(19) United States
(12) Patent Application Publication
(10) Pub. No.: US 2009/0255645 A1
(43) Pub. Date: Oct. 15, 2009

(54) Device and Method for Climate Control

(76) Inventor: Ulrich Ladstaetter, Weinstadt (DE)

Correspondence Address: KENYON & KENYON LLP, ONE BROADWAY, NEW YORK, NY, 10004, US

(21) Appl. No.: 12/223,495

(22) PCT Filed: Jan. 5, 2007
(86) PCT No.: PCT/EP2007/050121

§ 371 Date: Dec. 5, 2008

(30) Foreign Application Priority Data
Feb. 13, 2006 (DE) 10 2006 006 436.4

(51) Int. Cl. B60H 1/00

(52) U.S. Cl. 165/11.1; 165/204

(57) ABSTRACT

A device for climate control includes at least one data interface for outputting first such control data for an actuator unit of an air inlet into a driver footwell such that the footwell is cooled relative to the remaining space surrounding the driver and for outputting second control data to a unit for warming the remaining space surrounding the driver such that the remaining space surrounding the driver is at least partially heated, and thus the physiological active chain that commences when the driver is drowsy is interrupted.

### BACKGROUND OF THE INVENTION

1. Field of the Invention

The present invention relates to a device and a method for climate control in a motor vehicle.

2. Description of Related Art

A drowsiness detection in which the driver of a vehicle is monitored by a camera is already known from published European patent document EP 1418082. The recorded image is evaluated to determine whether the driver's eyes are open or closed. If it is detected that the driver is fatigued, the air conditioner of the vehicle is set such that it outputs cold air or that it adds a peppermint aroma to the output air.

### BRIEF SUMMARY OF THE INVENTION

In contrast to this, the climate control device according to the present invention has the advantage that only the driver's footwell is selectively cooled. The temperature of the remaining space surrounding the driver is increased or at least kept stable. Until now, it has been assumed that a drop in the body's core temperature is the factor that initiates the sleep phase when a person becomes drowsy. Yet further investigations have revealed that the reduction of the body's core temperature comes about due to the fact that the blood vessels in the extremities are dilated. The dilation of the blood vessels results in an increased blood circulation in the extremities. The increased blood circulation likewise causes an increased dissipation of heat into the atmosphere. This increased dissipation of heat causes the body's core temperature to drop. This sequence in the human organism may be considered a physiological active chain for inducing sleep. Inducing only a cooling of the person to be kept awake may increase drowsiness in that this possibly even accelerates the decrease in the body's core temperature. According to the present invention, an intervention is made in the active chain of inducing sleep in such a way that the driver's legs, which are in the footwell, are cooled. This results in a constriction of the blood vessels in the legs so that the dissipation of body heat is minimized. However, in order to counteract a reduction of the body's core temperature by the cooling, the remaining space surrounding the driver is at least partially heated to supply heat to the driver's body in another place or at least to contain a dissipation of heat. The climate control system according to the present invention performs an appropriate regulation. The appropriate setting ensures both that the dissipation of heat from the driver is reduced and that simultaneously the body's core temperature is maintained. This intervention in the active chain for inducing sleep interrupts the active chain or at least hinders its progress. Consequently it is possible to counteract the process of the driver falling asleep.

It is particularly advantageous to output control data for a seat heater in order to supply heat to the body of the driver. If a seat heater is triggered, the heat generated there acts directly on the driver, but not on the other passengers in the vehicle. Thus, they are not disturbed by the heat regulation. Additionally, a seat heater responds very quickly and is able to warm up quickly so that a necessary amount of heat may be supplied promptly. In this context, it is particularly advantageous to trigger the seat heater such that it heats itself to a temperature above 36° C. and thus takes on a temperature that is higher than the body temperature of the driver. With this kind of heating, it is possible not only to rule out a loss of heat on the part of the driver, but also an amount of heat is able to be effectively supplied to the body of the driver.

It is additionally advantageous to provide an interface for monitoring the temperature in the driver's footwell. On the one hand, this makes it possible to reduce the temperature as desired in the driver's footwell, and on the other hand to ensure that the temperature does not fall so low that the driver perceives the cooling as uncomfortable or that hypothermia possibly occurs. Additionally, a temperature sensor may be used to detect that a desired target temperature has been reached for the footwell. If the target temperature is not measured even after some time, a fault in the climate control may be thereby detected.

It is additionally advantageous to provide an interface for triggering motor actuators for closing vehicle openings, for example, the sunroof or the windows of the vehicle. Opening windows or similar vehicle openings may possibly result in a further cooling of the vehicle interior and thus of the driver. The temperature equilibrium that is to be set by the climate control device according to the present invention may be disturbed. An effect that results in the driver being kept awake may possibly likewise be impaired thereby. In particular, the activation of the climate control according to the present invention thus causes closable vehicle openings, like windows of a vehicle, for example, to be closed automatically by the motor actuators.

It is additionally advantageous to provide a timing circuit for terminating a cooling of the footwell. In particular, a strong cooling of the limbs in the footwell is thereby avoided.

Additionally, it is advantageous to provide one or multiple sensors for monitoring vehicle openings like the window or the sunroof, for example. If the driver opens a window, the cooling caused by this and the turbulence caused by a draft may impair the effect of keeping the driver awake. If a window or the sunroof is opened, a cooling of the footwell may thus also be deactivated.

It is furthermore advantageous to display the status of the climate control according to the present invention via an interface. In this way, the driver is able to detect whether the vehicle climate is already being regulated such that an effect of keeping the driver awake is to be expected.

The use of a climate control device according to the present invention in a motor vehicle is particularly advantageous since accidents from drowsiness are frequent and also it is not always possible to immediately terminate a drive when tiredness is detected.

### BRIEF DESCRIPTION OF THE SEVERAL VIEWS OF THE DRAWING

FIG. 1 shows a view of an instrument panel in a motor vehicle having a climate control device according to the present invention.

FIG. 2 shows a schematic side view of a motor vehicle with driver and a climate control device according to the present invention.

FIG. 3 shows a climate control device according to the present invention together with components of the motor vehicle.

FIG. 4 shows a sequence of a climate control method according to the present invention.

### DETAILED DESCRIPTION OF THE INVENTION

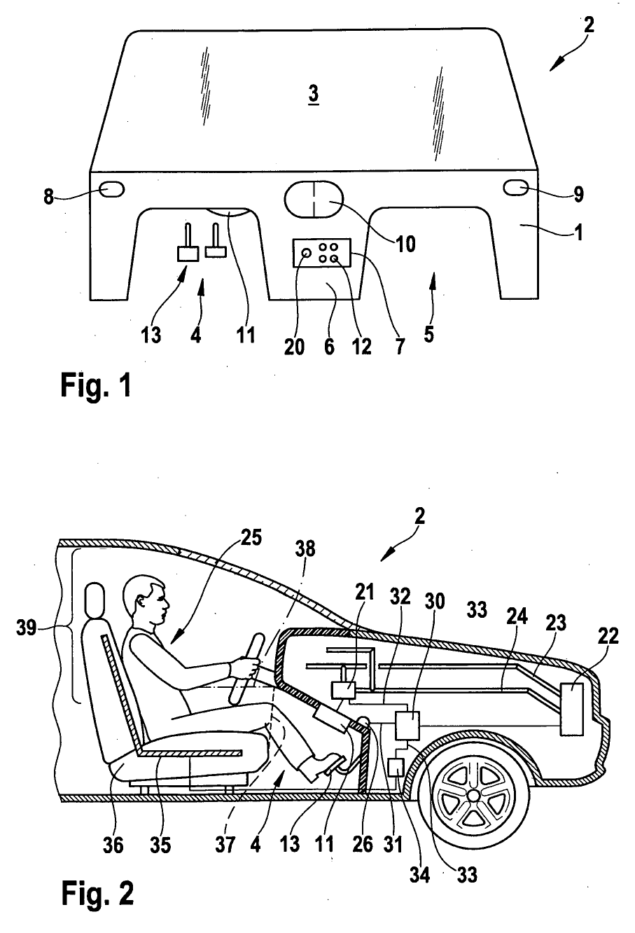

FIG. 1 shows an instrument panel 1 in a motor vehicle 2 that connects to the lower side of a windshield 3. The instrument panel leaves space for a driver footwell 4 and for a passenger footwell 5. The footwells 4, 5 are separated by a center console 6. Additionally, pedals 13 for control of vehicle 2 are located in driver footwell 4. An operating unit 7 that is used to control the climate in the vehicle is disposed in the region of center console 6 of instrument panel 1. It is connected to a climate control device in the vehicle that is not shown in FIG. 1. The climate control device is connected on the one hand to sensors in the vehicle, on the other hand to an air conditioner, fans, and/or ventilation actuators in the vehicle. To introduce fresh air into the interior of the vehicle, an air inlet 8 is disposed on the left side, an air inlet 9 is disposed on the right side, and an air inlet 10 is disposed in the region of the center console, for example. Additionally, the driver footwell has an air inlet 11. Operating unit 7 has control elements 12 for controlling the corresponding temperature of the vehicle interior. For example, if a driver desires a temperature of 22° for the interior of the vehicle, the air conditioner of vehicle 2 is triggered in such a way that air of such a temperature flows into the interior of the vehicle via air inlets 8, 9, 10, 11 so that after a certain time the desired temperature is reached. Furthermore, operating unit 7 has a button 20 that is used for adjusting the climate control according to the present invention. If a driver presses button 20, the climate control device outputs such triggering data to the actuating units of the air inlet that cold air, whose temperature is preferably less than 18° C., is blown into driver footwell 4 via air inlet 11. In contrast, air of a temperature that is desired by the driver for the remaining interior of the vehicle continues to be let in, at least via air inlets 8, 10. In one specific embodiment of the present invention, air that is warmer than the temperature desired by the driver may also be let in via these air inlet openings. This warmer air may balance out the heat loss caused in the entire interior of the vehicle by the supply of cold air to the driver's footwell.

This climate control results in a cooling of the driver's footwell while heat is supplied to the remaining space surrounding the driver. In this context, the temperature in the interior of the vehicle in the region of the driver is set so that a temperature of 18° C. prevails in the footwell, for example. The air temperature is kept at 21° C. in the remaining space surrounding the driver, for example. If the thermal conditions in the vehicle are stable, the air mixes only slightly due to the higher specific gravity of the cold air mass in the footwell. Thus, a boundary layer will appear between the colder air in the footwell and the remaining space surrounding the driver.

FIG. 2 shows a schematic side view of climate control device 30, including the devices connected to it. Climate control device 30 is preferably provided in instrument panel 1; however, it may also be disposed behind the dash panel in the engine compartment. In this context, climate control device 30 is connected via an interface, for example, an electronic data bus, for example, a LIN bus, to an actuating unit 21 for regulating air supply via air inlet 11 in driver footwell 4. On the one hand, the vehicle's air conditioner 22 supplies warm air to actuating unit 21 via a warm air line 23 and on the other hand cold air via a cold air line 24. Climate control device 30 triggers actuating unit 21 such that it blows cold air into driver footwell 4. In this instance, the cold air may have a temperature of 15° C. to 18° C., for example, but it may also be even colder. In this context, the temperature in footwell 4 of driver 25 is measured via a temperature sensor 26, the temperature in driver footwell 4 being checked by climate control device 30. The latter communicates to actuating unit 21 via interface 32 what temperature the air to be output in footwell 4 is to have. To this end, the actuating unit mixes the warm and cold air supplied to it in such a way that a desired air temperature of a maximum of 18° C. is reached. In this context, the regulation of the air supply is optionally predefined via interface 32.

In a preferred embodiment, climate control device 30 is connected via an additional interface 33 to an actuating unit 34 for regulating the temperature of a seat heater 35 of driver 25. When cold air flows into footwell 4, actuating unit 34 activates seat heater 35 in driver seat 36. By this means, at least an additional cooling off of the core of the driver's body is prevented. Preferably, however, the seat heater is set to a temperature above 36° C., for example, 42° C., so that heat is effectively provided to the driver. In one additional specific embodiment, climate control device 30 may also be connected via an interface not shown in FIG. 2 to an additional actuating unit for supplying ventilation, for example, for air inlets 8 and 10. When cold air is blown into the footwell, the actuating unit regulates the air supply in such a way that warmer air, 3° warmer than the interior vehicle temperature desired by the driver, for example, is then blown into the vehicle interior via these air inlets. To this end, air inlets 8, 10 are likewise connected to air supply lines 23, 24.

The seat heater or the supply of warm air to the space surrounding the driver thus accordingly does not completely heat all of the space surrounding the driver, but heat is provided to at least parts of the space surrounding the driver. The means for heating the remaining space surrounding the driver, which is at least partially heated, ensure that the cooling off of the driver's body is lessened or that heat is even provided to the driver by the heat supply.

In FIG. 2, the driver's footwell 4 is delimited by a dashed line 37. In this connection, it is not possible to define a sharp boundary for the footwell. A possible, imaginary line may be the line that connects the instrument panel with the front edge of the driver's seat. In a region in particular up to dot-dash line 38, air mixtures may occur. The remaining space, that is, the remaining air surrounding the driver, indicated by bracket 39, remains essentially uninfluenced by the cold air blown into footwell 4 via air inlet 11.

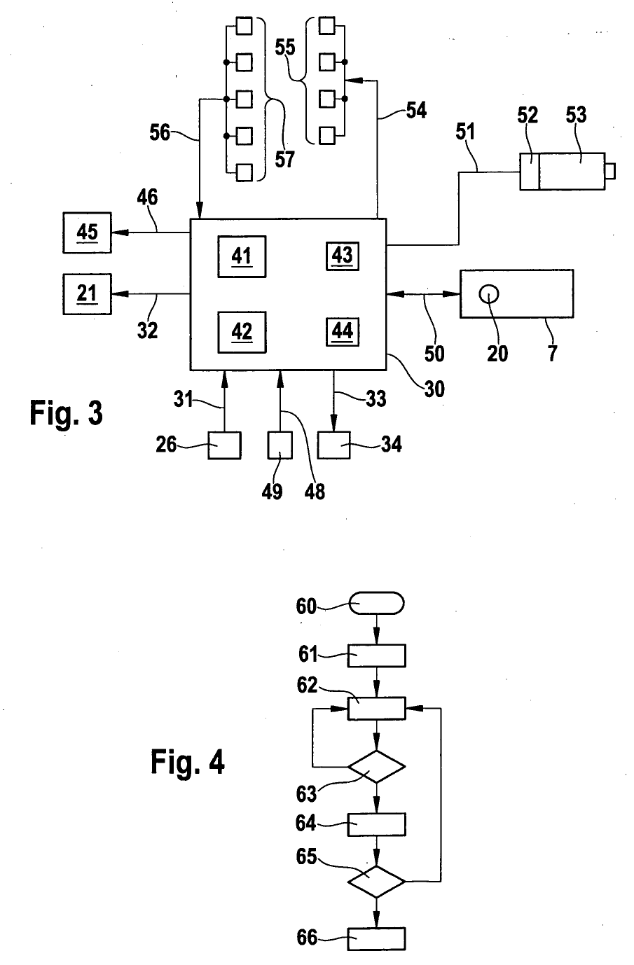

FIG. 3 illustrates in detail a schematic representation of climate control device 30 according to the present invention. Climate control device 30 has a processing unit 41 that processes data supplied by the sensors and outputs the corresponding control data for the air supply to the driver footwell and for the means for heating the remaining space surrounding the driver. Additionally, climate control device 30 has a memory unit 42 in which corresponding program data for implementing the method according to the present invention are stored in a non-volatile manner. In a preferred embodiment, the climate control device furthermore has an additional memory 43 in which corresponding parameters for the climate control may be stored as a function of the vehicle. By this means it is possible to implement the climate control device according to the present invention in different types of vehicle, the parameters having to be adjusted to the specific type of vehicle. Preferably, additionally a time circuit 44 is provided with which the duration of a supply of cold air to driver footwell 4 is able to be monitored and regulated.

Climate control device 30 according to the present invention is preferably embodied as a control device that is disposed in an associated, separate housing. This housing may be connected in a location provided for this purpose in instrument panel 1 or in the engine compartment on the driver side. An operating voltage is provided via a suitable electric interface. One or multiple plugs for connecting the climate control device to sensors and actuating units in the vehicle are disposed on the housing. Devices connected to the climate control device may be addressed or provide information to the climate control device either directly or via a data bus. For example, a CAN bus or a LIN bus may be used as a data bus.

Actuating unit 21 for supplying air to footwell 4 is connected to climate control device 30 via an interface 32. Actuating unit 34 for the seat heater is connected via interface 33 to climate control device 30. An actuating unit 45 for supplying air to the vehicle's interior is connected via an interface 46. Additionally, interface 31 is provided for temperature sensor 26, and an interface 48 for an interior temperature sensor 49 for monitoring the space 39 surrounding the driver. Operating unit 7 is connected to climate control device 30 via a bidirectional interface 50. In an additional specific embodiment, the climate control device may also have an interface 51 to a drowsiness monitoring unit 52 that monitors the driver's eye opening using a camera device 53, for example, or detects a drowsiness of the driver with the aid of an evaluation of travel data. Actuating motors 55, which are used to close the windows, for example, may be triggered via an interface 54. Sensors in the vehicle that detect the opening of the windows or of the sunroof or adjustments to the climate control or the seat heater setting made by the driver, for example, may be read out via an interface 56.

The sequence of the method according to the present invention is explained in the following with the aid of FIG. 4. The climate control device is activated via an initialization step 60 to the effect that a climate control for keeping the driver awake is set. In a first specific embodiment, this initialization may take place in that the device for drowsiness monitoring unit 52 reports a drowsiness of the driver. However, corresponding devices are very costly. For this reason, in a preferred specific embodiment, the initialization may take place via an actuation of button 20. In this connection, button 20 is preferably embodied as a push-button. Alternatively, a selection may also take place via the selection in a corresponding menu in an operator interface shown in a display. For the selection, an appropriate symbol is selected in the operator interface. In this context, feedback about the status of the climate regulation for keeping the driver awake is preferably given via button 20 or via the symbolic representation of a control panel in a display. If the corresponding climate control is not active, button 20 is dark, for example, or the symbol is shown as darkened.

Once initialization step 60 has occurred, this is followed by a preparation step 61. In preparation step 61, sensors 57 check whether windows and/or the sunroof are open. If this is the case, motor actuators 55 close the windows and/or the sunroof. If one or multiple vehicle openings are not equipped with a motor actuator for automatically opening and closing, the driver is prompted by a suitable display, which is not shown in FIG. 3, to close the windows or the sunroof. For example, button 20 is then illuminated such that an activation of the climate regulation device according to the present invention is recognizable. A yellow light may be shown as confirmation that a button has been pressed, for example. To this end, the status of the climate regulation is transmitted via interface 50 to operating unit 7.

In a climate regulation step 62, actuator units 21 and seat heater 35 and/or actuator unit 45 for supplying ventilation to the remaining vehicle interior are triggered by climate control device 30 such that at this point the footwell is cooled and the remaining space surrounding the driver is supplied with heat to maintain the body's core temperature. In a subsequent first check step 63 a check is done to see whether the target temperature, in particular of the driver footwell, has already been reached. If this is not the case, then a branch back to climate regulation step 62 is carried out and the climate regulation remains unchanged or a cooling of footwell 4 is even increased in that even colder air is supplied. However, if it is determined in the first check step 63 that the target temperature of footwell 4 has been reached, then further branching takes place to an adjustment step 64 in which button 20 changes to a green display. Button 20 may correspondingly be illuminated by an inner light-emitting diode that may be triggered in multiple colors. The symbol representation is accordingly varied in a symbolic representation of button 20 in a display. After adjusting step 64, the method branches to a second check step 65. In the second check step 65, a check is done to see whether a specified duration for a cooling off of the footwell, for example, a duration of one hour after setting the desired parameters for the air temperature, has already been reached. If this is the case, the climate control is adjusted back to a previously set temperature and the method is terminated with a final step 66. If, on the other hand, it is determined that the duration of, for example, one hour has not yet been reached, then the method branches back to climate regulation step 62.

If the driver unexpectedly intervenes in the climate control, thus, for example, if sensors 57 detect an opening of a window or an opening of a sunroof or a manual deactivation of the seat heater, then preferably a warning is displayed to the driver. A warning may be given in that button 20 blinks red, for example.

On the one hand, the interfaces of the climate control device may be implemented in hardware, that is, a corresponding hardware connection may be provided for each unit that is connected to the climate control device. However, in another specific embodiment, these interfaces may also be implemented in software so that data flow through one or multiple bus connections, the interfaces being embodied such that the data from the climate control device are transported to the corresponding unit desired by climate control device 30 or, in the opposite direction, are read out.

1-10. (canceled)

11. A climate control device, comprising:
a first interface configured to output first control data for an actuating unit configured to control an air supply to a driver footwell such that the footwell is cooled relative to the remaining space surrounding the driver; and
a second interface configured to output second control data to a heating mechanism configured to heat at least a portion of the remaining space surrounding the driver.

12. The device as recited in claim 11, wherein the second control data are configured as control data for a seat heater, and wherein the seat heater is the heating mechanism configured to heat at least a portion of the remaining space surrounding the driver.

13. The device as recited in claim 12, wherein the second control data for the seat heater are configured such that the seat heater warms up to more than 36° C.

14. The device as recited in claim 12, further comprising:
a further interface configured for at least one temperature sensor configured to monitor a temperature of the driver footwell.

15. The device as recited in claim 12, further comprising:
a further interface configured to trigger at least one motor actuator for closing at least one vehicle opening.

16. The device as recited in claim 12, further comprising:
a timer circuit configured to terminate cooling of the driver footwell after a predefined time.

17. The device as recited in claim 12, further comprising:
a further interface configured for at least one sensor for monitoring a vehicle opening; and
a processing unit configured to monitor whether the vehicle opening has been opened.

18. The device as recited in claim 12, further comprising:
a further interface configured for displaying a status of climate control performed by the climate control device.

19. The device as recited in claim 12, wherein the device is configured as a climate control device in a motor vehicle.

20. The device as recited in claim 12, further comprising:
a control button, wherein activation of the control button causes the climate control device to output triggering data to an actuating unit of the air inlet such that cold air is blown into the driver footwell via the air inlet.

21. A method for climate control in a motor vehicle, comprising:
outputting, by a control unit via a first interface, first control data for an actuating unit configured to control an air supply to a driver footwell such that the footwell is cooled relative to the remaining space surrounding the driver; and
outputting, by the control unit via a second interface, second control data to a heating mechanism configured to heat at least a portion of the remaining space surrounding the driver.
